(19) United States
(12) Patent Application Publication
(10) Pub. No.: US 2009/0196749 A1
(43) Pub. Date: Aug. 6, 2009

(54) PRENTICE WIND ENGINE

(76) Inventor: Charles E. Prentice, Beaverton, OR (US)

Correspondence Address: SMITH-HILL AND BEDELL, P.C., 16100 NW CORNELL ROAD, SUITE 220, BEAVERTON, OR, 97006, US

(21) Appl. No.: 12/026,779

(22) Filed: Feb. 6, 2008

(51) Int. Cl. F03D 3/00

(52) U.S. Cl. 416/140

(57) ABSTRACT

The Prentice Wind Engine will operate 100% from “wind power” from any direction to produce both air pressure as well as hydraulic pressure at the same time to work together to generate electricity. In the case of the Prentice Wind Engine, assuming that the wind is coming from the north direction, panel #1 is facing north in the closed position and receives the full force from the north wind. As it rotates, the wind spills out and air and gravity push the panel away from its based hinged position and in doing so, produces two functions, wind force from its rotation and pressure force from the hydraulic cylinder. As it proceeds through the 360° circle it gradually “feathers” back to its first closed position, ready to repeat the sequence, and the other wind panels follow the same sequence. Also, these units can be stacked one above the other to function as one unit.

### BACKGROUND OF THE INVENTION

This invention relates to wind engines and, in particular, to wind engines having hinged panels.

U.S. Pat. No. 7,258,527 discloses a wind engine that comprises a vertical shaft and a rotor mounted on the vertical shaft for rotation about a vertical axis. The rotor has several radial arms and an equal number of panels attached to the arms respectively. Each panel is pivotable relative to its arm about a vertical axis at the outer end of the arm. A stop prevents rotation of the panel in the clockwise direction (when viewed from above) relative to the arm beyond the position in which the panel is substantially parallel to the arm and extends radially.

When the wind engine is exposed to wind blowing in a horizontal direction, the rotor rotates in the counterclockwise direction about the vertical axis and the panels tend to align themselves with the wind direction, subject to the action of the stops. The rotor may be coupled to an electric power generator. The wind engine thereby converts wind energy to electrical energy.

### SUMMARY OF THE INVENTION

In accordance with the invention there is provided a wind engine comprising a vertical shaft and a rotor mounted on the vertical shaft for rotation thereabout, the rotor including a plurality of frames each extending radially of the shaft, a panel attached to each frame for pivotal movement relative to the frame between a closed position, in which the panel is in a substantially vertical plane disposed substantially radially of the shaft and presents maximum resistance to wind in a horizontal direction, and an open position in which the panel is feathered relative to wind in a horizontal direction, a means for preventing rotation of the panel relative to the radial frame beyond the closed position, in the direction from the open position towards the closed position, and an energy recovery means effective between the panel and the frame for recovering energy when the panel pivots relative to the frame.

### BRIEF DESCRIPTION OF THE DRAWINGS

For a better understanding of the invention, and to show how the same may be carried into effect, reference will now be made, by way of example, to the accompanying drawings, in which:

FIG. 1 is an isometric view of a wind engine embodying the present invention,

FIG. 2 is a schematic side elevation of the wind engine,

FIG. 3 is a top plan view of the wind engine,

FIG. 4 is an enlarged sectional partial view of the wind engine, and

FIG. 5 is a schematic diagram illustrating operation of the wind engine to drive an hydraulic motor.

### DETAILED DESCRIPTION

The illustrated wind engine comprises a stator 2 and a rotor 6. The stator 2 includes a base 10 attached to the ground and a vertical shaft 14 extending upward from the base 10. The rotor 6 includes a tubular shaft 18 that is coaxial with the shaft 14 and is supported for rotation relative to the stator about the central axis of the shaft 14 by a thrust bearing 22 and rotary bearings 24. The rotor 6 also includes four support frames 28 that extend radially from the tubular shaft 18. Each frame comprises upper and lower arms 32 and a secondary vertical shaft 34 mounted for rotation relative to the arms 32 in suitable bearings (not shown).

A wind panel 36 is attached to each secondary shaft 34. The wind panel may comprise upper and lower spars 38 and a light, but nevertheless stiff, sail 40 attached to the spars. It will be convenient in the following description to refer to the front and rear surfaces of the wind panel relative to rotation of the rotor about the shaft 14. Stops 44 attached to the upper and lower arms 32 limit rotation of the wind panel 36 relative to the frame 28 in the clockwise direction when viewed from above.

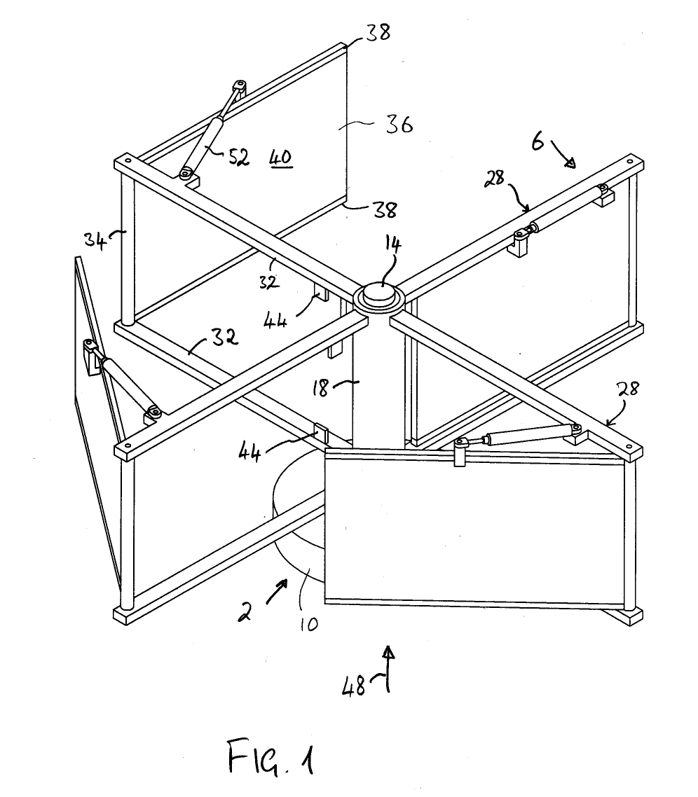

It will become apparent from the following description that when the wind engine is exposed to wind blowing in a horizontal direction, the rotor rotates in the counterclockwise direction when viewed from above. Referring to FIGS. 1 and 3, let us assume that the wind is blowing from the south as indicated by the arrow 48. When a frame 28 is oriented west, the wind panel attached to the frame is oriented north and presents minimum resistance to the wind. As the rotor rotates in the counterclockwise direction, a hydraulic pump 52, which will be described in greater detail below, prevents the wind panel from aligning immediately with the wind direction as the frame rotates towards a southerly orientation and accordingly the wind is incident on the rear surface of the panel and applies a force that tends to rotate the panel in the clockwise direction relative to the frame 28 against resistance due to operation of the hydraulic pump 52. The pump transfers force from the wind panel to the frame 28, urging the rotor to rotate in the counterclockwise direction. When the frame attains a southerly orientation, the wind panel may be oriented approximately north west.

When the frame 28 rotates beyond the southerly orientation, the wind remains incident on the rear surface of the wind panel and the force due to the wind continues to urge the panel to rotate in the clockwise direction relative to the frame. Force transmitted to the frame 28 by the hydraulic pump 52 continues to urge the rotor to rotate in the counterclockwise direction. By the time the frame reaches an easterly orientation, the panel extends radially of the shaft 18 and further rotation of the panel in the clockwise direction relative to the frame is prevented by the stops 44. Force applied to the rear surface of the panel and transferred to the frame by the stops 44 urge the rotor to rotate in the counterclockwise direction. The wind panel remains in a radial orientation relative to the shaft as the frame rotates to a northerly orientation.

When the frame 28 rotates beyond the northerly orientation, the wind catches the front surface of the wind panel and the panel turns vigorously in the counterclockwise direction relative to the frame to the tangential orientation, subject to resistance by the pump 52, until the frame is oriented west and the panel is oriented north.

It will thus be seen that regardless of wind direction, the rotor will rotate in the counterclockwise direction and because the panel tends to remain aligned with the wind direction (subject to the constraint imposed by the stops 44) each wind panel rotates alternately clockwise and counterclockwise relative to its support frame, between a radial orientation and a tangential orientation.

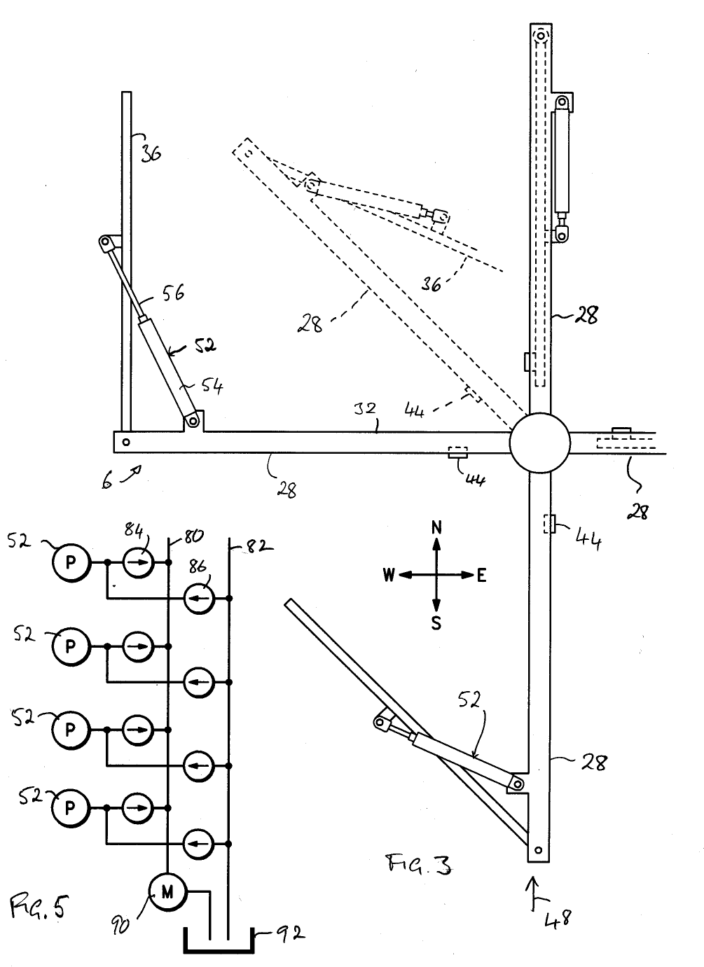

Referring to FIGS. 1-3, the hydraulic pump 52 comprises a cylinder 54 that is attached to the upper arm 32 and a piston 56 that is slidable within the cylinder and has a rod that is attached to the upper spar 38 of the panel. Rotation of the panel relative to the frame 28 in the clockwise direction (when viewed from above) drives the piston into the cylinder and pressurizes the cylinder chamber whereas rotation in the counterclockwise direction retracts the piston from the cylinder and depressurizes the cylinder chamber. The cylinder chamber is connected by a flexible hose 60 (FIG. 4) to a fitting that is attached to the shaft 18 and provides communication between the hose 60 and a radial bore 64 in the shaft 18.

Between the upper and lower rotary bearings 24, the inner shaft 14 is formed with five peripheral grooves 68, three of which are shown in FIG. 3. O-rings 72 are fitted in the grooves 68 and are in sliding, sealing contact with the interior surface of the outer shaft 18, defining four mutually isolated annular channels 76, two of which are shown in FIG. 3. The four radial bores 64 in the shaft 18 communicate with the channels 76 respectively.

The inner shaft 14 is formed with a longitudinal pressure duct 80 and a longitudinal return duct 82. Each annular channel 76 is in one way communication with the pressure duct and the return duct via respective check valves 84, 86.

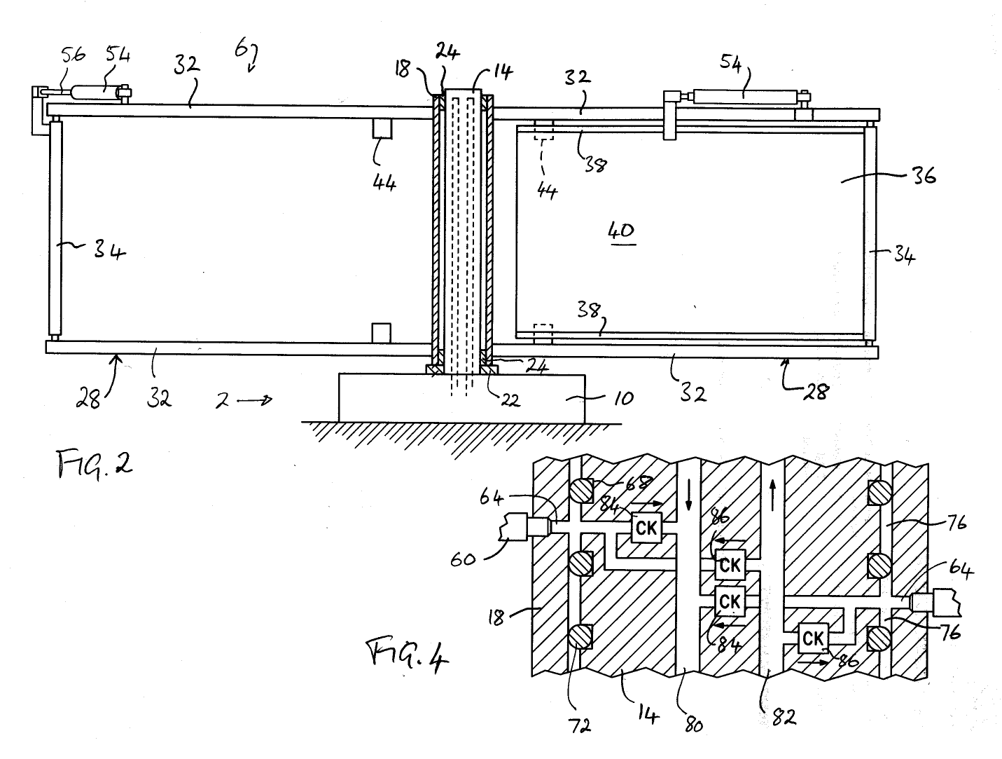

Referring to FIG. 5, the pressure duct 80 is connected to the pressure side of a rotary hydraulic motor 90 which discharges low pressure fluid to a reservoir, and the return duct 82 is connected to the reservoir 92. Referring again to FIGS. 1 and 2, when a wind panel 36 turns to the radial orientation relative to the shaft 18, the piston is urged into the cylinder and hydraulic fluid in the cylinder chamber is pressurized. The pressurized fluid is delivered to the motor 90 by way of the hose 60, bore 64, check valve 84 and pressure duct 80. When the panel turns back to the tangential orientation, the piston is withdrawn from the cylinder and the pressure in the cylinder chamber is reduced. The action of the piston draws hydraulic fluid from the reservoir 92 through the suction duct 82, check valve 86, radial bore 64, and hose 60.

The pressure duct 80 may be connected to a pressure accumulator (not shown) for attenuating variations in pressure in the pressure duct.

The motor 90 may be connected to drive a suitable power consuming device, such as a water pump or an electricity generator. The pressure ducts 80 of multiple wind engines may be connected together for supplying pressurized hydraulic fluid to a common consuming device.

It will be appreciated that although the wind engine has been described above in connection with a wind from the south, operation of the wind engine is not dependent on the wind direction.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A wind engine comprising a vertical shaft and a rotor mounted on the vertical shaft for rotation thereabout, the rotor including:
a plurality of frames each extending radially of the shaft,
a panel attached to each frame for pivotal movement relative to the frame between a closed position, in which the panel is in a substantially vertical plane disposed substantially radially of the shaft and presents maximum resistance to wind in a horizontal direction, and an open position in which the panel is feathered relative to wind in a horizontal direction,
a means for preventing rotation of the panel relative to the radial frame beyond the closed position, in the direction from the open position towards the closed position, and
an energy recovery means effective between the panel and the frame for recovering energy when the panel pivots relative to the frame.

2. A wind engine according to claim 1, wherein each frame has an outer end, each panel is attached to the respective frame for pivotal movement about a vertical axis at the outer end of the frame and the energy recovery means comprises an hydraulic pump connected between the panel and frame.

3. A wind engine according to claim 2, wherein the hydraulic pump comprises an hydraulic cylinder attached to the frame and a piston fitted slidably in the cylinder and attached to the panel.
